(19) United States
(12) Patent Application Publication
(10) Pub. No.: US 2020/0291232 A1
(43) Pub. Date: Sep. 17, 2020

(54) ADDITIVE PHOSPHORUS-CONTAINING POLYSILOXANE COMPOUND FOR THERMOSETTING RESINS, FLAME RETARDANT COMPOSITION COMPRISING SAME, AND ARTICLES MADE THEREFROM

(71) Applicant: ICL-IP America Inc., Tarrytown, NY (US)

(72) Inventors: Andrew PIOTROWSKI, Yorktown Heights, NY (US); Meng ZHANG, White Plains, NY (US)

(21) Appl. No.: 16/768,209

(22) PCT Filed: Dec. 3, 2018
(86) PCT No.: PCT/US2018/063539

§ 371 Date: May 29, 2020

Related U.S. Application Data
(60) Provisional application No. 62/595,334, filed on Dec. 6, 2017.

(51) Int. Cl. C08L 83/08; C08L 71/12; C08G 77/30; C08G 77/00; C08K 5/00

(52) U.S. Cl. CPC C08L 83/08; C08L 71/126; C08G 77/30; C08K 3/36; C08K 5/0066; C08L 2201/02; C08G 77/70

(57) ABSTRACT

There is provided herein a flame retardant composition containing a thermosetting resin and a phosphorus-containing polysiloxane flame retardant, which flame retardant composition can be used in prepregs, laminate, bonding sheets and printed wiring boards.

This application claims priority to U.S. Provisional Application No. 62/595,334 filed on Dec. 6, 2017, the entire contents of which are incorporate herein by reference.

### FIELD OF THE INVENTION

The present invention relates to the field of flame retardants, specifically phosphorus-containing flame retardants for electronic applications such as printed circuit boards.

### BACKGROUND OF THE INVENTION

The rapidly developing electronics industry, especially that of consumer electronics, is in need of products that have light weight, high density, high reliability, high functionality, and low power consumption. This requires electronic components to have higher signal transmission speed and transmission efficiency, with high signal integrity and very low power loss. This requires dramatic improvement in the performance of printed circuit board carriers. In addition, the high speed and multi-functionalization of electronic products requires improvement in dimensional stability and thermal stability as well as electrical properties such as dielectric constant and loss tangent to ensure signal stability and minimize power loss at high frequencies, while providing acceptable flame retardancy performance.

The current FR-4 materials used to make such printed circuit boards does not meet the application demand for high frequencies, dimensional stability and high thermal stability. A high demand for improved properties of laminates, has led to the use of non-epoxy resins which have superior thermal, mechanical and chemical properties. However, there still remains a demand for a halogen-free flame retardant that can be used with both epoxy and non-epoxy systems.

WO2017067124 describes the use of an organic silicon resin containing unsaturated double bonds in formulations of polyphenylene ether (PPE) resin. This formulation has a three-dimensional net structure and has the advantages of a low dielectric constant, a low dielectric loss, high heat resistance, low water absorption, a high interlayer adhesive force, and a high bending strength, and is also very suitable as a circuit substrate for high-speed electronic equipment. However, the PPE resin used therein is not flame retarded, and the addition of typical flame retardants impairs the improved performance of the PPE resin.

CN101445520 describes a phosphoric organic silicon compound made from an addition reaction of an active phosphorus-hydrogen bond in a 9,10-dihydro-9-oxa-10-phosphaphenanthrene-10-oxide (DOPO) derivative and siloxane containing two carbon-carbon double bonds to produce the novel phosphoric organic silicon compound. The compound containing both phosphorus and silicon is used as an additive flame retardant to achieve UL94 V-0 in thermosets such as epoxy and modified PPE resins. However, the low molecular weight and low crosslinking ability of this phosphoric organic silicon compound results in poor thermal properties such as low glass transition temperature Tg and low thermal stability.

Compared to linear siloxane compounds, cage silsequioxanes have a higher Tg and better thermal properties and consist of only siloxane bonds. However, most cage silsesquioxanes still have a relatively low Tg (<150° C.) due to a flexible Ts-cage structure.

While Chernyy, Sergey at Journal of Applied Polymer Science, 132(19), 41955/1-41955/9; 2015 describes a co-polymer made from 10-(2-trimethoxysilyl-ethyl)-9-hydro-9-oxa-10-phosphaphenanthrene-10-oxide (DOPO) and tetraethyl orthosilicate, it is only described as a flame retardant for cotton fiber.

### SUMMARY OF THE INVENTION

Applicants herein have unexpectedly discovered that the addition of a suitable bridging/crosslinking group (such as e.g., tetra-functional silicon) by hydrolytic polycondensation of alkoxysilanes can prevent the formation of large flexible cage silsequioxanes, resulting in a polysiloxane with a more rigid structure and higher Tg. In addition, the bridging/crosslinking group maintains the loose packing structure containing some free volume, leading to a superb dielectric constant and loss factor. Even more surprisingly applicants have found that the invented polysiloxane can be used as a very efficient flame retardant for electronic materials, such as printed wiring board (PWB).

There is provided herein in one non-limiting embodiment a flame retardant composition comprising a thermosetting resin and a phosphorus-containing polysiloxane flame retardant which contains at least one moiety of the formula R¹:

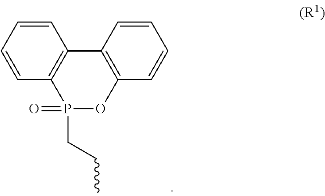

It is understood herein that the curving line in R1 is an indication of a bond to a silicone moiety in the phosphorus-containing polysiloxane flame retardant.

More specifically herein, the phosphorus-containing polysiloxane flame retardant which contains at least one moiety of the formula R¹ is of the general formula (I):

(SiO₂)ₘ(R¹ₚSiO_{(4-p)/2})ₙ(R²ᵣSiO_{(4-r)/2})ₒ (I)

where R¹ is

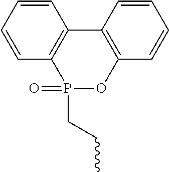

where R² is selected from the group consisting of an alkyl group of from 1 to 4 carbon atoms, and

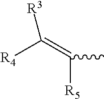

wherein R³, R⁴, R⁵ are independently selected from H or an alkyl group of from 1 to 4 carbon atoms, and
where m is >0; n is ≥1; o is ≥0; and, m/(n+o) is from 0 to 1; o/n is from 0 to 1; 1≤p≤3; and, 1≤r≤3.

Even more specifically, the phosphorus-containing polysiloxane flame retardant has the general structure (II):

(SiO₂)ₘ(R¹SiO_{3/2})ₙ(R²SiO_{3/2})ₒ (II)

where R¹ is

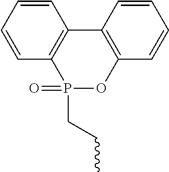

where R² is selected from the group consisting of an alkyl group of from 1 to 4 carbon atoms, and

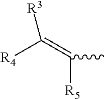

wherein R³, R⁴, R⁵ are independently selected from H or an alkyl group of from 1 to 4 carbon atoms, and
where m is >0, n is ≥1, o is ≥0, and m/(n+o) is from 0 to 1; and o/n is from 0 to 1.

### DETAILED DESCRIPTION OF THE INVENTION

The present invention is directed to surprising discovery that the above-provided flame retardant composition is a novel and unexpectedly superior flame retardant composition for electronic applications such as the non-limiting example of printed wiring boards.

The flame retardant can be employed in electronic applications while maintaining high thermal resistance and thermal stability, high adhesive force, low water absorbance, low dielectric loss tangent, and simultaneously, a sufficiently low dielectric constant.

The phosphorus-containing polysiloxane flame retardant compound(s) of the general formula (I) above can be used as the flame retardant compound for thermosetting resins, such as those described herein.

In one embodiment, the phosphorus-containing polysiloxane flame retardant is formed by hydrolytic polycondensation of alkoxysilanes comprising a mixture of at least 2 components having the formulae R¹Si(OR⁶)₃ and Si(OR⁷)₄ resulting in the formation of a compound with general structure (I) containing covalent —Si—O—Si— bonds where R¹ is as defined above; and R⁶ and R⁷ each are independently selected from alkyl groups of from 1 to 4 carbon atoms.

In another embodiment, the phosphorus-containing polysiloxane flame retardant is formed by hydrolytic polycondensation of alkoxysilanes comprising a mixture of at least 3 components having the formulae R¹Si(OR⁶)₃, Si(OR⁷)₄ and R²Si(OR⁸)₃ resulting in the formation of a compound with general structure (I) containing covalent —Si—O—Si— bonds where R¹, and R², are as defined; R⁶, R⁷, and R⁸ each are independently selected from alkyl groups of from 1 to 4 carbon atoms.

In yet another embodiment, the phosphorus-containing polysiloxane flame retardant is formed by hydrolytic polycondensation of silanols, and/or silyl chlorides comprising a mixture of at least 2 components having the formulae R¹SiR⁹₃ and SiR¹⁰₄ resulting in the formation of a compound with general structure (I) containing covalent —Si—O—Si— bonds where R¹ is as defined above; and, R⁹, and R¹⁰ each are independently selected from —OH and —Cl groups.

In yet even another embodiment, the phosphorus-containing polysiloxane flame retardant is formed by hydrolytic polycondensation of silanols, and silyl chlorides comprising a mixture of at least 3 components having the formulae R¹SiR⁹₃, SiR¹⁰₄ and R²SiR¹¹₃ resulting in the formation of a compound with general structure (I) containing covalent —Si—O—Si— bonds where R¹, and R² are defined above; and, R⁹, R¹⁰, and R¹¹ each are independently selected from —OH and —Cl groups.

In one embodiment in the general formulae (I) or (II), m>0, preferably m is from 1 to 100, even more preferably m is from 1 to 70.

In another embodiment, in the general formulae (I) or (II), the ratio of the subscripts m/(n+o) is from 1/10 to ¾, preferably from ⅕ to about ½.

In yet another embodiment, in the general formulae (I) or (II), the ratio of the subscripts o/n is from 0 to ½, preferably from 0 to ⅓, and most preferably from 0.05 to ⅓.

It will be understood herein that even though the formulae (I) and (II) do not expressly set forth terminal “M” silicone units, i.e., R₃SiO_{1/2} units, wherein each R is independently an alkyl of from 1 to 4 carbon atoms, preferably methyl, such formulae (I) and (II) will be understood to contain the same “M” units in the amount and valence of the specific silicone compound used of formulae (I) or (II). In one embodiment, the formula (II) can be a sub-genera of the formula (I). In another embodiment one or both of formula (I) and (II) can each independently contain at least one silicone “T” and “Q” unit, of the respective formulae RSiO_{3/2}, and SiO_{4/2}, wherein R is as defined above, i.e., an alkyl of from 1 to 4 carbon atoms, preferably methyl. In another embodiment herein, the formulae (I) and/or (II) can be in the absence of a silicone “D” unit, i.e., of the formula R₂SiO_{2/2} wherein R is as defined above, an alkyl of from 1 to 4 carbon atoms, preferably methyl. Further still in another embodiment, the silicone of formulae (I) or (II) can contains only “M”, “T” and “Q” silicone units, as defined herein above.

In one embodiment herein in formulae (I) and/or (II), the moiety R¹

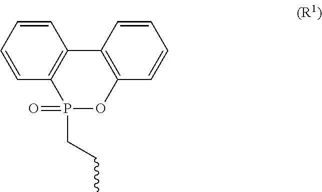

is present on one or more of the aforementioned silicone “T” units in formulae (I) or (II), but can also optionally be present on one or more of the aforementioned silicone “M” or “D” units, wherein the R1 moiety is present in place of one, two or three of the R 1-4 carbon atom alkyl moieties of the aforementioned “M”, “D” and “T” silicone units. In another embodiment herein, the formulae (I) and/or (II) can each have an R¹ moiety only on the silicone “T” units. It will be understood that each of formulae (I) and (II) will have at least one (R¹) moiety as noted above.

The terms, “comprising,” “including,” “containing,” “characterized by,” and grammatical equivalents thereof are inclusive or open-ended terms that do not exclude additional, unrecited elements or method steps, but will also be understood to include the more restrictive terms “consisting of” and “consisting essentially of.”

In one embodiment of the flame retardant composition herein the thermosetting resin is selected from the group consisting of modified polyphenylene ether (PPE), modified polyphenylene ether oligomers, polyphenylene ether-polystyrene blends, epoxy, polyurethane, polyisocyanates, benzoxazine ring-containing compounds, unsaturated resin systems containing double or triple bonds, polycyanate ester, bismaleimide, triazine, bismaleimide and mixtures thereof.

Most preferably, the thermosetting resin is a modified polyphenylene ether and/or an oligomer thereof.

More specifically, the modified polyphenylene ether or its oligomer, has two or more vinyl groups, allyl groups, preferably one on each end of the molecular chain, and is not particularly limited as to the structure which can be used.

In the present invention, modified polyphenylene ether resin with vinyl end-groups can be represented by the following general formula (IIa) which is preferable:

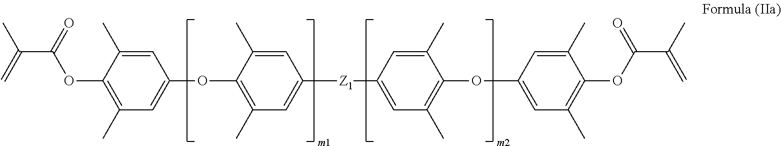

In Formula II, Z₁ is a divalent moiety derived from compounds selected from the group consisting of bisphenol A, bisphenol F, bisphenol S, naphthalene, anthracene, biphenyl, tetramethyl biphenyl, phenol novolac, cresol novolac, bisphenol A novolak, DOPO-HQ (10-(2,5-Dihydroxyphenyl)-9,10-dihydro-9-oxa-10-phospha phenanthrene-10-oxide) and the group consisting of borane compounds, and m₁ and m₂ are each independently an integer of from 3 to about 20, preferably from about 4 to about 15 and most preferably from about 5 to about 10. A commercial example of such modified PPE is SA9000 from Sabic.

The expression “derived from compounds” as used above is understood to mean that the compound has two hydrogen atoms removed therefrom to provide for two valences which can bridge the adjacent moieties in Formula (IIa) above.

In the present invention, those compounds of the formula (IIa) having at least two vinyl groups at both ends of the molecular chain are preferably used. However, it is also possible to use a conventional unsaturated double bond moiety known in the art in addition to the vinyl group.

It is difficult to produce a multilayer sheet with conventional polyphenylene ether because polyphenylene ether has high melting point and therefore has a high melt viscosity of the resin composition. Therefore, in one embodiment herein the modified polyphenylene ether as described herein is high molecular weight PPE which can in one embodiment be modified to a low molecular weight PPE obtained through a redistribution reaction of high molecular weight PPE.

In one non-limiting embodiment herein, a high molecular weight PPE is understood to be a PPE with a number average molecular weight above the ranges described herein for the modified PPE component.

In one embodiment herein, conventional polyphenylene ether can be modified and used as low-molecular polyphenylene ether having a vinyl group at both terminals through a redistribution reaction using a polyphenol and a radical initiator as a catalyst followed by a modification of the terminal hydroxyl group for example with acryolyl or methacryolyl chloride These modified polyphenylene ethers have low dielectric loss even after crosslinking. These modified polyphenylene ethers have lower molecular weight than conventional polyphenylene derived compounds and therefore are soluble in conventional solvents used for varnish preparation and have improved flowability in the production of laminated plates. Therefore, a printed circuit board manufactured using the flame retardant composition of the present invention has an advantage of improving physical properties such as moldability, workability, dielectric properties, heat resistance and adhesive strength.

Some non-limiting examples of specific bisphenol compounds having an increased alkyl content and aromatic content which can be used herein in a redistribution reaction of high molecular weight PPE, can be selected from the group consisting of bisphenol A [BPA, 2,2-Bis (4-hydroxyphenyl) propane], bisphenol AP (1,1-bis (4-hydroxyphenyl)-1-phenyl-ethane), bisphenol AF (2,2-Bis (4-hydroxyphenyl) butane), bis-(4-hydroxyphenyl) diphenylmethane, bis (3-methyl-4-hydroxyphenyl) propane, bis (4-hydroxyphenyl)-2,2-dichloroethylene, 2,2-bis (4-hydroxy-3-isopropyl-phenyl) propane, 1,3-Bis (4-hydroxyphenyl) sulfone, 5,5′-(1-Methylethyliden)-bis [1,1′-(bisphenyl)-2-ol] Propene, 1,1-bis (4-hydroxyphenyl)-3,3,5-trimethyl-cyclohexane, 1,1-bis (4-hydroxyphenyl)-cyclohexane, mixtures thereof, and the like.

The polyphenylene ether resin herein may be modified to have a low molecular weight in the range of 1,000 to 10,000, preferably the number average molecular weight (Mn) is in the range of 1,000 to 5,000, and more preferably in the range of 1,000 to 3,000.

In the flame retardant composition according to the present invention, the content of the modified polyphenylene ether resin or oligomer thereof may be about 10 to 80% by weight based on the total weight of the resin, preferably from about 15 to about 60% by weight and most preferably from about 20 to about 50% by weight.

In one embodiment herein, the flame retardant composition can be such that it further comprises a second thermosetting resin such as an epoxy resin. In one non-limiting embodiment, the epoxy resin can be present in the flame retardant composition in an amount of from about 0.1% by weight to about 25% by weight, preferably from about 1 to about 15% by weight, and most preferably from about 1 to about 5% by weight of the flame retardant composition.

The epoxy resin can be such as those selected from halogen-free epoxies, phosphorus-free epoxies, and phosphorus-containing epoxies, and mixtures thereof, including, but not limited to, DEN 438, DER 330 Epon 164 (DEN and DER are trademarks of The Dow Chemical Company), epoxy functional polyoxazolidone-containing compounds, cycloaliphatic epoxies, GMA/styrene copolymers, and the reaction product of DEN 438 and DOPO resins, and combinations of any of the foregoing. The most preferred are low Dk and low Df epoxies for example DCPD (such as EPICLON HP-7200 series) epoxy or epoxidized polybutadiene.

In one embodiment, the flame retardant composition herein may further comprise a crosslinking agent containing a carbon-carbon double bond which is selected from the group consisting of (1) a hydrocarbon crosslinking agent, (2) a crosslinking agent containing at least 3 functional groups, (3) a rubber having a block or random structure; and (4) combinations thereof.

The hydrocarbon-based crosslinking agent (1) usable in the present invention is not particularly limited as long as it is a hydrocarbon-based crosslinking agent having a double bond or a triple bond, and may preferably be a diene crosslinking agent. Specific examples thereof include butadiene (e.g., 1,2-butadiene, 1,3-butadiene and the like) or a polymer thereof, e.g, polybutadiens; decadiene (e.g., 1,9-decadiene) or a polymer thereof, polydecadienes; octadiene, etc. or a polymer thereof, vinylcarbazole, etc. These may be used alone or in combination of two or more.

According to one example, polybutadiene represented by the following formula (III) may be used as the hydrocarbon-based crosslinking agent.

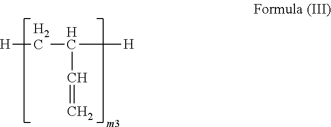

In the above Formula (III), m₃ is an integer of 10 to 30.

The molecular weight (Mw) of the hydrocarbon crosslinking agent may range from 500 to 3,000, preferably from 1,000 to 3,000.

Non-limiting examples of crosslinking agents containing three or more (preferably three to four) functional groups (2) usable in the present invention include triallyl isocyanurate (TAIC), 1,2,4-trivinylcyclo 1,2,4-trivinyl cyclohexane (TVCH), etc. These may be used alone or in combination of two or more.

According to one example, triallyl isocyanurate (TAIC) represented by the following formula (IV) can be used as a crosslinking agent containing three or more functional groups.

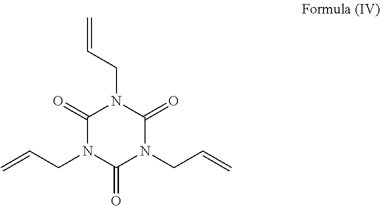 [SMILES: C=CCn1c(=O)n(CC=C)c(=O)n(CC=C)c1=O]

The rubber of the block or random structure crosslinking agent (3) usable in the present invention may be in the form of a block copolymer, preferably a rubber in the form of a block copolymer containing a butadiene unit, more preferably a butadiene unit and a styrene unit, an acrylonitrile unit, an acrylate unit, and the like. Non-limiting examples include styrene-butadiene rubber (SBR), acrylonitrile-butadiene rubber, acrylate-butadiene rubber, acrylonitrile-butadiene-styrene rubber, etc. Random copolymer poly(styrene-co-butadiene) can also be used. These may be used singly or in combination of two or more kinds.

According to one example, a styrene-butadiene rubber represented by the following formula (V) can be used as a rubber having a block structure.

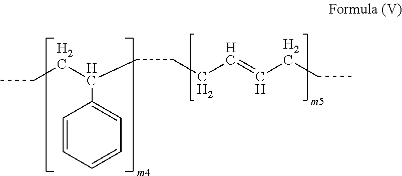

wherein m₄ is an integer up to 500, and m₅ is an integer up to 2100.

A styrene-butadiene copolymer has a number average molecular weight up to 150,000 and includes 1,2 vinyl groups having cross-linking properties. Such copolymer including 1,2-vinyl having cross-linked properties is for example a copolymer having a structure represented by Formula (VI):

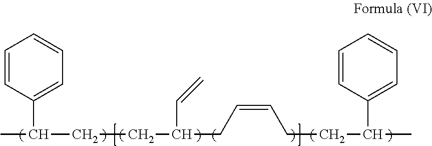

The number average molecular weight is equal or greater than 2000. The number average molecular weight can be in the range of 2,000-150,000, and more preferably 3,000-120,000. In the styrene-butadiene rubber of the invention a styrene content is preferably from 20 to 80 wt. % and butadiene content is preferably from 50 to 80% wt. A 1,2-vinyl content in butadiene blocks is preferably from 40 to 85%.

In the flame retardant composition of the present invention, the content of the crosslinking agent having a carbon-carbon unsaturated double bond is not particularly limited, but may be in the range of about 5 to 50% by weight based on the total weight of the resin composition, preferably about 10 to 45%. In one alternate embodiment, the content of the crosslinking agent having a carbon-carbon unsaturated double bond is from about 1% by weight to about 30% by weight based on the weight of the flame retardant composition. When the content of the cross-linkable curing agent falls within the above-mentioned range, the flame retardant composition has a low dielectric property, curability, moldability and adhesion.

According to one example, when the hydrocarbon crosslinking agent (1) and the crosslinking agent containing three or more functional groups (2) are mixed with PPE crosslinking hardeners, the content of the crosslinking agent (2) containing more than one functional group is in the range of about 1 to 10% by weight, preferably about 2 to 5% by weight.

If necessary, in addition to the above-mentioned hydrocarbon-based crosslinking agents, the present invention may further include a conventional crosslinking curing agent known in the art. At this time, it is preferable that the cross-linkable curing agent has excellent compatibility with polyphenylene ether modified with a vinyl group, an allyl group or the like.

Non-limiting examples of some such conventional crosslinking agents are those selected from the group consisting of divinylnaphthalene, divinyldiphenyl, styrene monomer, phenol, triallyl cyanurate (TAC), di-(4-vinylbenzyl) Ether, and combination thereof.

The flame retardant composition may also comprise initiators in order to induce the generation of free radicals at high temperature in the unsaturated portions of the thermosetting resin. These initiators can include peroxide and non-peroxide initiators. The peroxide initiator is selected from one or more of dicumyl peroxide, t-butyl perbenzoate, 2,5-dimethyl-2,5-di(t-butylperoxy) hex-3-yn, di(t-butyl) peroxide, t-butyl cumyl peroxide, di(t-butylperoxy-m-isopropyl)benzene, 2,5-dimethyl-2,5 di(t-butylperoxy)hexane, di(t-butylperoxy) isophthalic acid, 2,2-di(t-butylperoxy)butane, (benzylphthalidyl peroxy)hexane, di(trimethylsilyl) peroxide. Usually, the non-peroxide initiator is selected from one or more of 2,3-dimethyl-2,3-diphenylbutane, and 2,3-trimethylsilyloxy-2,3-diophenylbutane.

The flame retardant composition can also optionally contain at least one co-crosslinker and/or optionally, one or more of a curing catalyst, a Lewis acid, an inhibitor, and a benzoxazine-containing compound. All of the above components of the flame retardant composition may be blended or mixed together in any order to form the flame retardant composition.

The flame retardant composition was prepared according to the present invention, made by blending a mixture of compound(s) of the general formula (I) described herein, the PPE resin, an optional epoxy resin, and optionally a crosslinker. The flame retardant composition may be used to make prepregs, laminates and circuit boards useful in the electronics industry and as a phosphorus-containing flame-retardant composition to coat metallic foils for so called build-up technology as described herein.

The compound(s) (a) of the general formula (I) described herein can be used as a filler material for a thermosetting resin composition as described herein, and will vary, depending on the specific thermosetting resin and the specific compound being employed, as well as the specific parameters of processing as are known by those skilled in the art. The compounds of the general formula (I) can be used as additives in of and by themselves, or in combination with any other organic or inorganic fillers, such as the non-limiting examples of mineral fillers, such as Al(OH)₃, Mg(OH)₂; silica, alumina, titania etc. In addition, compounds (I) of the invention herein can be used in combination with other flame retardants both reactive such as one described in U.S. Pat. No. 8,202,948, or additive such as described in U.S. Pat. No. 9,012,546, the entire contents of which are incorporated by reference herein in their entireties, and those others described herein. In one embodiment herein, the amount of filler other than the compound of the general formula (I) can be from about 1 to about 30 weight percent, from about 3 to about 25 weight percent and most preferably from about 5 to about 20 weight percent.

In one non-limiting embodiment, the effective flame-retardant amount of compound(s) of the general formula (I) described herein which can be used is from about 10 to about 250 parts by weight per 100 parts of the thermosetting resin component (e.g., PPE), more specifically from about 20 to about 200 parts by weight per 100 parts of the thermosetting resin component, and most specifically from about 30 to about 180 parts by weight per 100 parts of the thermosetting resin component. To provide adequate flame retardancy, the compositions herein will contain from 1% to about 5% phosphorus in the final composition. In one embodiment, the above stated amounts of compound(s) of the general formula (I) described herein can be the amounts of compound(s) of the general formula (I) described herein used in any of the compositions described herein.

As described above, the flame retardant compositions described herein may be formed by blending compound(s) of the general formula (I) described herein, at least one thermosetting resin, optionally at least one epoxy resin, and optionally at least one crosslinker, as well as any of the other optional components described herein; or in another embodiment, the flame retardant compositions may be formed by blending at least one compound of the general formula (I), at least one PPE resin, at least one epoxy resin, and at least one crosslinker, as well as any of the other optional components described herein.

With any of the compositions above where an epoxy resin is present, any number of co-crosslinking agents (i.e., in addition to the crosslinking agent having carbon-carbon unsaturated double bonds described herein) may optionally also be used. Suitable co-crosslinkers that may optionally be present in combination with the thermoset compounds according to the present invention include, for example, multifunctional co-crosslinkers as are known to those skilled in the art.

The co-crosslinkers include, for example, copolymers of styrene and maleic anhydride having a molecular weight (M_{w}) in the range of from 1,500 to 50,000 and an anhydride content of more than 15 percent. Commercial examples of these materials include SMA 1000, SMA 2000, and SMA 3000 and SMA 4000 having styrene-maleic anhydride ratios of 1:1, 2:1, 3:1 and 4:1, respectively, and having molecular weights ranging from 6,000 to 15,000, which are available from Elf Atochem S.A.

Other less preferred co-crosslinkers useful in the present invention include hydroxyl-containing compounds. Other phenolic functional materials can also be used but are not as suitable and they include co-crosslinkers which upon heating form a phenolic crosslinking agent having a functionality of at least 2. In one embodiment herein, the flame retardant composition can have a low level of phenolic compounds, such as from about 0.001 to about 5%, preferably from about 0.01 to about 2% and most preferably from about 0.01 to about 1% of phenolic compound based on the entire weight of the flame retardant composition.

Any of the flame retardant compositions of the present invention described herein may optionally comprise a curing catalyst. Examples of suitable curing catalyst materials (catalyst) useful in the present invention include compounds containing amine, phosphine, ammonium, phosphonium, arsonium or sulfonium moieties or mixtures thereof. Particularly preferred catalysts are heterocyclic nitrogen-containing compounds.

The amount of optional curing catalyst used depends on the molecular weight of the catalyst, the activity of the catalyst and the speed at which the polymerization is intended to proceed. In general, the curing catalyst is used in an amount of from 0.01 parts per 100 parts of resin (p.h.r.) to about 1.0 p.h.r., more specifically, from about 0.01 p.h.r. to about 0.5 p.h.r. and, most specifically, from about 0.1 p.h.r. to about 0.5 p.h.r.

The curable composition of the present invention may optionally have boric acid and/or maleic acid present as a cure inhibitor. In that case, the curing agent is preferably a polyamine or polyamide. The amount of cure inhibitor will be known by those skilled in the art.

The flame retardant compositions of the present invention may also optionally contain one or more additional flame retardant additives including, for example, red phosphorus, encapsulated red phosphorus or liquid or solid phosphorus-containing compounds, for example, “EXOLIT OP 930”, EXOLIT OP 910 from Clariant GmbH and ammonium polyphosphate such as “EXOLIT 700” from Clariant GmbH, XP-7866 from Albemarle, a phosphite, or phosphazenes; nitrogen-containing fire retardants and/or synergists, for example melamines, melem, cyanuric acid, isocyanuric acid and derivatives of those nitrogen-containing compounds; halogenated flame retardants and halogenated epoxy resins (especially brominated epoxy resins); synergistic phosphorus-halogen-containing chemicals or compounds containing salts of organic acids; inorganic metal hydrates such as Sb₂O₃, Sb₃O₅, aluminum trihydroxide and magnesium hydroxide, such as “ZEROGEN 30” from Martinswerke GmbH of Germany, and more preferably, an aluminum trihydroxide such as “MARTINAL TS-610” from Martinswerke GmbH of Germany; boron-containing compounds; antimony-containing compounds; silica and combinations thereof.

When additional flame retardants which contain phosphorus are present in the composition of the present invention, the phosphorus-containing flame retardants are preferably present in amounts such that the total phosphorus content of the total resin composition is from 0.2 wt. percent to 5 wt. percent.

The flame retardant compositions of the present invention may also optionally contain other additives of a generally conventional type including for example, stabilizers, other organic or inorganic additives, pigments, wetting agents, flow modifiers, UV light blockers, and fluorescent additives. These additives can be present in amounts of from 0 to 5 wt. percent and are preferably present in amounts of less than 3 wt. percent.

The flame retardant composition is preferably free of bromine atoms, and more preferably free of halogen atoms.

The present invention is particularly useful for making B-staged prepregs, laminates, bonding sheets, and resin-coated copper foils by well-known techniques in the industry.

In one embodiment herein there is provided an article that contains any of the flame retarded composition(s) described herein. In one embodiment the article herein can be used in lead-free soldering applications and electronic devices, e.g., printed circuit board applications. Specifically, the article can be a prepreg and/or a laminate. In one specific embodiment there is provided a laminate and/or a prepreg that contains any one or more of the flame retardant compositions described herein. In one other embodiment there is provided herein a printed circuit board, optionally a multilayer printed circuit board, comprising one or more prepreg(s) and/or a laminate (either uncured, partially cured or completely cured) wherein said prepreg(s) and/or laminate comprises any one or more of the flame retardant compositions described herein. In one embodiment there is provided a printed circuit board comprising a prepreg and/or a laminate, wherein said prepreg and/or laminate comprises any one of the flame retardant compositions described herein.

Partial curing as used herein can comprise any level of curing, short of complete cure, and will vary widely depending on the specific materials and conditions of manufacture as well as the desired end-use applications. In one specific embodiment, the article herein can further comprise a copper foil. In one embodiment the article can comprise a printed circuit board. In one embodiment there is provided a non-epoxy laminate which comprises a prepreg and/or laminate of the invention. In a more specific embodiment there is provided a printed circuit board comprising a non-epoxy laminate, wherein the non-epoxy laminate comprises a prepreg or laminate of the invention.

In one embodiment herein there is provided a process for making a laminate that contains any of the flame retardant compositions described herein, which process comprises impregnating the respective composition(s) into a filler material, e.g., a glass fiber mat to form a prepreg, followed by processing the prepreg at an elevated temperature and/or pressure to promote a partial cure to a B-stage and then laminating two or more of said prepregs to form said laminate. In one embodiment, said laminate and/or prepreg can be used in the applications described herein, e.g., printed circuit boards.

It is provided herein, that any of the flame retardant compositions described herein are useful for making a prepreg and/or laminate with a good balance of laminate properties and thermal stability, such as one or more of high T_{g} (i.e. above 130° C.), a T_{d} of 330° C. and above, a T₂₈₈ of 5 minutes and above, a flame resistance rating of V-0, good toughness, and good adhesion to copper foil. In recent years the T_{d} has become one of the most important parameters, because the industry is changing to lead-free solders which melt at a higher temperature than traditional tin-lead solders.

In one embodiment herein, the flame retardant compositions described herein can be used in other applications, e.g., encapsulants for electronic elements, protective coatings, structural adhesives, structural and/or decorative composite materials, in amounts as deemed necessary depending on the particular application.

### EXAMPLES

### Example 1: Synthesis of DOPO-Siloxane

10-(2-trimethoxysilyl-ethyl)-9-hydro-9-oxa-10-phosphaphenanthrene-10-oxide (DOPO-H) (432.4 g, 2.0 mol) and vinyltriethoxysilane (VTES) (399.7 g, 2.1 mol) were mixed together. The suspension was heated to 120° C. and formed a heterogeneous solution (molten DOPO—H layer on the bottom). t-Butyl peroxide (4 mL) was added dropwise into the reaction mixture within 30 min, tiny bubbles generated when peroxide reached the solution, and a homogeneous solution formed in a short time. The mixture was stirred at 120° C. for another 2 hours. At the end of the reaction, ³¹P NMR showed that less than 1 mol % of DOPO-H was left. The product DOPO-triethoxysilane (DOPO-TES) is a clear liquid. ³¹P NMR (121 MHz, CDCl₃, ppm) δ 40. ¹H NMR (300 MHz, CDCl₃, ppm) δ 7.0-8.0 (m, 8H), 3.3-3.5 (m, 9H), 1.8-2.3 (m, 2H), 0.6-1.1 (m, 2H).

3.3 g of methanol, 0.6 g of water and 2.0 g of acetic acid were mixed together and added into 12 g of DOPO-TES dropwise over 15 min at 0° C. The reaction mixture was stirred at 100° C. for 4 hours. The mixture was a homogenous solution instead of a suspension; therefore, it is believed a cage-like structure formed instead of a linear/branched one. The solvent was removed and the product (DOPO-Siloxane) is a white foam. ³¹P NMR (121 MHz, CDCl₃, ppm) δ 37-42. ¹H NMR (300 MHz, CDCl₃, ppm) δ 7.0-8.0 (m, 8H), 1.8-2.3 (m, 2H), 0.6-1.1 (m, 2H). TGA 95 wt % is at 218° C.

### Example 2: Synthesis of DOPO-Siloxane

DOPO-Siloxane was prepared using procedures in Example 1. The product was then heated at 165° C. for 2 h to fully react any left-over Si—OH groups. After heating, the TGA 95 wt % is at 359° C.

### Example 3: Synthesis of DOPO-Vinyl-Siloxane

DOPO-TES was prepared using procedures in Example 1. 3.3 g of methanol, 0.6 g of water and 2 g of acetic acid were mixed together and added into a mixture of 10 g of DOPO-TES and 1.3 g of VTES dropwise over 15 min at 0° C. The reaction mixture was stirred at 100° C. for 4 hours. The solvent was removed and the product is a white foam. ³¹P NMR (121 MHz, CDCl₃, ppm) δ 37-42 (product). ¹H NMR (300 MHz, CDCl₃, ppm) δ 7.0-8.0 (m, 8H), 5.3-6.0 (m, 1.8), 1.8-2.3 (m, 2H), 0.6-1.1 (m, 2H). The ratio between DOPO- and vinyl-groups is determined to be 5:3 based on the proton NMR. The product was then heated at 150° C. for 2 h to fully react any left-over Si—OH groups. After heating, the TGA 95 wt. % is at 318° C.

### Example 4: Synthesis of DOPO-TEOS-Siloxane

DOPO-TES was prepared using procedures in Example 1. 3.3 g of methanol, 0.6 g of water and 2.0 g of acetic acid were mixed together and added into a mixture of 10 g of DOPO-TES and 2.1 g of tetraethyl orthosilicate (TEOS) dropwise over 15 min at 0° C. The reaction mixture was stirred at 100° C. for 4 hours. The solvent was removed and the product is a white foam. The product was then heated at 165° C. for 2 h to fully react any left-over Si—OH groups. After heating, the TGA 95 wt. % is at 267° C.

### Example 5: Synthesis of DOPO-Vinyl-TEOS-Siloxane

DOPO-TES was prepared using procedures in Example 1. 7.1 g of ethanol, 2.9 g of water and 0.67 g of acetic acid were mixed together and added into a mixture of 14.3 g of DOPO-TES, 3.0 g of VTES, and 1.3 g of TEOS dropwise over 15 min at 0° C. The reaction mixture was stirred at 100° C. for 4 hours. The solvent was removed and the product is a white foam. The product was then heated at 170° C. for 2 h then 220° C. for 1 h to fully react any left-over Si—OH groups. After heating, the TGA 95 wt. % is at 318° C.

### Example 6: Synthesis of Silica-Containing DOPO-Vinyl-TEOS-Siloxane

DOPO-TES was prepared using procedures in Example 1. 7.1 g of ethanol, 2.9 g of water and 0.67 g of acetic acid were mixed together and added into a mixture of 12.0 g of DOPO-TES, 2.8 g of VTES, and 2.3 g of TEOS dropwise over 15 min at 0° C. The reaction mixture was stirred at 100° C. for 5 min, and then 2.5 g of silica was added. The suspension was heated at 100° C. for 4 hours. The solvent was removed and the product is a white foam. The product was then heated at 170° C. for 2 h then 220° C. for 1 h to fully react any left-over Si—OH groups. After heating, the TGA 95 wt. % is at 400° C.

TABLE 1
Materials

| | Trade Name (Producer) | General Information | Function |
|---|---|---|---|
| A-1 | SA9000 (ex Sabic) | Modified PPE with vinyl | Polyphenylene |
| | | end-group | ether resin |
| A-2 | EPON 164 (ex Momentive) | Cresol novolac epoxy | Epoxy resin |
| A-3 | DEN 438 (ex Dow Chemicals) | Phenol novolac epoxy | Epoxy resin |
| A-4 | SD-1708 (ex Momentive) | Phenolic novolac | Curing agent |
| B-1 | B-1000 (ex NIPPON SODA) | A homopolymer of butadiene | Crosslinking |
| | | | agent |
| B-2 | Triallyl isocyanurate (ex Aldrich) | 1,3,5-Triallyl-1,3,5-triazine- | Crosslinking |
| | | 2,4,6(1H,3H,5H)-trione | agent |
| B-3 | B-2000 (ex NIPPON SODA) | A homopolymer of butadiene | Crosslinking |
| | | | agent |
| B-4 | SBS Rubber (ex Firestone Polymers LLC) | Tri-block copolymer with | Crosslinking |
| | | 33% polystyrene blocks and | agent |
| | | 67% polybutadiene blocks | |
| C-1 | Sample from Example 1 | Phosphorus-containing | Flame retardant |
| | | siloxane in Preparation | |
| | | Example 1 | |
| C-2 | Sample from Example 2 | Phosphorus-containing | Flame retardant |
| | | siloxane in Preparation | |
| | | Example 2 | |
| C-3 | Sample from Example 3 | Phosphorus-containing | Flame retardant |
| | | siloxane in Preparation | |
| | | Example 3 | |
| C-4 | Sample from Example 4 | Phosphorus-containing | Flame retardant |
| | | siloxane in Preparation | |
| | | Example 4 | |
| C-5 | Sample from Example 5 | Phosphorus-containing | Flame retardant |
| | | siloxane in Preparation | |
| | | Example 5 | |
| C-6 | Sample from Example 6 | Phosphorus-containing | Flame retardant |
| | | siloxane in Preparation | |
| | | Example 6 | |
| D-1 | Dicumyl peroxide (ex Aldrich) | Dicumyl peroxide | Catalyst |
| D-2 | 2-MI (ex Air Products) | 2-methyl imidazole | Catalyst |
| E | Silica (ex Denka) | Fused silica | Filler |
| | MEK (ex Aldrich) | 2-Butanone | Solvent |
| | Toluene (ex Aldrich) | | Solvent |

### Examples 7-14: Thermosetting Curing Experiments with Siloxane Compounds

Samples from Examples 1-6 were cured using SA9000, B-1000 and TAIC with dicumyl peroxide as catalyst using the formulations in Table 2. Toluene or MEK was used as solvent. The sample-PPE blends were cured at 175° C. for 2 hours and post-cured at 190° C. for 1 hour. Sample from Example 5 was also cured using epoxy resins EPON164 and DEN438, and phenolic novolac SD-1708 with catalyst 2-MI (see Table 2 Example 13). MEK was used as solvent. The sample-epoxy blend was cured at 172° C. for 2 hours and post-cured at 187° C. for 1 hour. A low and medium level PPE (SA9000) formulation was developed in Example 14. A formulation with higher level of hydrocarbon resins and silica were tested with sample from Example 5. The level of SA9000 was reduced and the level of B-2000, TAIC and SBR rubber were increased. To compensate for higher flammability silica was also added to the formulation. Sample from Example 5 was cured using SA9000, B-2000, TAIC and SBR rubber with dicumyl peroxide as catalyst and silica as filler (Solvent Toluene, Table 2 Example 14). The sample-PPE blend was cured at 175° C. for 2 hours and post-cured at 190° C. for 1 hour. Thermostability of the samples were studied using DSC and TGA, the results are shown in Table 2.

TABLE 2

| | Example | Example | Example | Example | Example | Example | Example | Example |
|---|---|---|---|---|---|---|---|---|
| Example | 7 | 8 | 9 | 10 | 11 | 12 | 13 | 14 |
| P % | 2.0 | 2.0 | 2.0 | 2.0 | 2.2 | 2.2 | 2.3 | 2.5 |
| A-1 | 64.3 | 64.3 | 62.1 | 62.1 | 60.4 | 54.8 | | 25.0 |
| A-2 | | | | | | | 26.8 | |
| A-3 | | | | | | | 21.9 | |
| A-4 | | | | | | | 25.8 | |
| B-1 | 13.7 | 13.7 | 13.2 | 13.2 | 12.8 | 11.7 | | |
| B-2 | 2.4 | 2.4 | 2.3 | 2.3 | 2.3 | 2.1 | | 9.0 |
| B-3 | | | | | | | | 14.4 |
| B-4 | | | | | | | | 3.6 |
| C-1 | 19.6 | | | | | | | |
| C-2 | | 19.6 | | | | | | |
| C-3 | | | 22.4 | | | | | |
| C-4 | | | | 22.4 | | | | |
| C-5 | | | | | 24.5 | | 25.5 | 28.0 |
| C-6 | | | | | | 31.4 | | |
| D-1 | 1.0 | 1.0 | 1.0 | 1.0 | 1.0 | 1.0 | | 1.0 |
| D-2 | | | | | | | 0.2 | |
| E | | | | | | | | 20.0 |
| Appearance | Foamy | Not | Not | Not | Not | Not | Not | Not |
| | | foamy | foamy | foamy | foamy | foamy | foamy | foamy |
| Tg ° C. | 145 | 140 | 163 | 169 | 188 | 200 | 180 | 200 |
| TGA | 391 | 430 | 423 | 429 | 428 | 431 | 381 | 422 |
| 95 wt % ° C. | | | | | | | | |
| Preliminary | Self- | Self- | Self- | Self- | Self- | Self- | Self- | Self- |
| Flammability | extinguished | extinguished | extinguished | extinguished | extinguished | extinguished | extinguished | extinguished |
| test | in 5 s | in 5 s | in 10 s | in 5 s | in 10 s | in 5 s | in 5 s | in 5 s |
| Dk at 1 | | | 2.63 | 2.70 | | | | |
| GHz | | | | | | | | |
| Df at 1 | | | 0.001 | 0.002 | | | | |
| GHz | | | | | | | | |

The flame retardancy of the thermosetting resin in Example 7 was satisfactory however the sample was foamy because of the presence of hydroxyl containing DOPO-siloxane from Example 1. Hydroxyl containing siloxane compound will continue the polycondensation reaction which generates water during the curing process, and such water vaporization will results in void formation in the PWB (Printed Wiring Board) and delamination during pressure cooking tests and therefore is unacceptable. The void formation can be avoided if siloxane samples are post-cured in elevated temperature resulting in highly crosslinked insoluble phosphorus containing siloxane (Example 2-6). For example, a post-curing of the DOPO-siloxane from Example 1 at 165° C. for 2 hours increases the thermal stability of the mixture from 218° C. to 359° C. (Example 2). And the thermoset using post-cured DOPO-siloxane is not foamy (Example 8). Surprisingly we have found that despite of formation of insoluble product, the siloxane samples (Example 2-6) performed as a very efficient flame retardant also providing cured resin with exceptional electrical properties. For example, samples of DOPO-Vinyl-Siloxane and DOPO-TEOS-Siloxane have superb Dk around 2.70 and Df less than 0.002 (Example 9-10). We have also found that addition of tetraalkoxysilanes and/or vinylalkoxysilanes during hydrolysis of DOPO-TES results in formation of product that when used in thermosetting resin exhibits better thermal properties and non-foamy appearances (Example 3-6 and 9-14). This is because tetraalkoxysilanes prevent the formation of large flexible cage silsequioxanes, resulting in a polysiloxane with a more rigid structure and higher Tg. In addition, the bridging/crosslinking group maintains the loose packing structure containing some free volume, leading to a superb dielectric constant and loss factor. Vinylalkoxysilanes can provide extra double-bond crosslinking with other thermosetting resins, resulting in a partially reactive FR with even higher Tg. It is also noted that DOPO-Vinyl-TEOS-Siloxane is compatible with epoxy resins and shows good thermal and flame-retardant properties (Example 13). A formulation with a low and medium level PPE (SA9000) and higher level of hydrocarbon resins and silica was developed with DOPO-Vinyl-TEOS-Siloxane. The prepared resin casting has very good thermal properties (Example 14). It is noted that when the amount of SA9000 is reduced, more silica or flame retardants are needed for the resin castings to pass the flammability test.

While the invention has been described with reference to certain embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention but that the invention will include all embodiments falling within the scope of the appended claims.

1. A flame retardant composition comprising a thermosetting resin and a phosphorus-containing polysiloxane flame retardant which has the general structure (I):
(SiO₂)ₘ(R¹ₚSiO_{(4-p)/2})ₙ(R²ᵣSiO_{(4-r)/2})ₒ (I)
where R¹ is 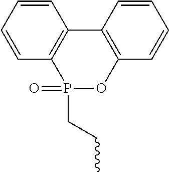
where R² is selected from the group consisting of an alkyl group of from 1 to 4 carbon atoms, and 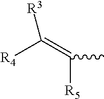
wherein R³, R⁴, R⁵ are independently selected from H or an alkyl group of from 1 to 4 carbon atoms, and
where m is >0; n is ≥1; o is ≥0; and, m/(n+o) is from 0 to 1; o/n is from 0 to 1; 1≤p≤3; and, 1≤r≤3.

2. The flame retardant composition of claim 1, wherein the phosphorus-containing polysiloxane flame retardant has the general structure (II):
(SiO₂)ₘ(R¹SiO_{3/2})ₙ(R²SiO_{3/2})ₒ (II)
where R¹ is 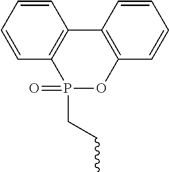
where R² is selected from the group consisting of an alkyl group of from 1 to 4 carbon atoms, and 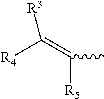
wherein R³, R⁴, R⁵ are independently selected from H or an alkyl group of from 1 to 4 carbon atoms, and
where m is >0, n is ≥1, o is ≥0, and m/(n+o) is from 0 to 1; and o/n is from 0 to 1.

3. The flame retardant composition of claim 1 wherein the phosphorus-containing polysiloxane flame retardant is formed by hydrolytic polycondensation of alkoxysilanes comprising a mixture of at least 2 components R¹Si(OR⁶)₃ and Si(OR⁷)₄ resulting in the formation of a compound with general structure (I) containing covalent —Si—O—Si— bonds where R¹ is as defined above; and R⁶ and R⁷ each are independently selected from alkyl groups of from 1 to 4 carbon atoms.

4. The flame retardant composition of claim 1 wherein the phosphorus-containing polysiloxane flame retardant is formed by hydrolytic polycondensation of alkoxysilanes comprising a mixture of at least 3 components R¹Si(OR⁶)₃, Si(OR⁷)₄ and R²Si(OR⁸)₃ resulting in the formation of a compound with general structure (I) containing covalent —Si—O—Si— bonds where R¹, and R², are as defined; R⁶, R⁷, and R⁸ each are independently selected from alkyl groups of from 1 to 4 carbon atoms.

5. The flame retardant composition of claim 1 wherein the phosphorus-containing polysiloxane flame retardant is formed by hydrolytic polycondensation of silanols, and/or silyl chlorides comprising a mixture of at least 2 components R¹SiR⁹₃ and SiR¹⁰₄ resulting in the formation of a compound with general structure (I) containing covalent —Si—O—Si— bonds where R¹ is as defined above; and, R⁹, and R¹⁰ each are independently selected from —OH and —Cl groups.

6. The flame retardant composition of claim 1 wherein the phosphorus-containing polysiloxane flame retardant is formed by hydrolytic polycondensation of silanols, and silyl chlorides comprising a mixture of at least 3 components R¹SiR⁹₃, SiR¹⁰₄ and R²SiR¹¹₃ resulting in the formation of a compound with general structure (I) containing covalent —Si—O—Si— bonds where R¹, and R² are defined above; and, R⁹, R¹⁰, and R¹¹ each are independently selected from —OH and —Cl groups.

7. The flame retardant composition of claim 1 wherein m/(n+o) is from 1/10 to about ¾.

8. The flame retardant composition of claim 1 wherein m/(n+o) is from ⅕ to about ½.

9. The flame retardant composition of claim 1 wherein o/n is from 0 to ½.

10. The flame retardant composition of claim 1 wherein o/n is from 0 to ⅓.

11. The flame retardant composition of claim 1 wherein the thermosetting resin is selected from the group consisting of modified polyphenylene ether, modified polyphenylene ether oligomers, polyphenylene ether-polystyrene blends, epoxy, polyurethane, polyisocyanates, benzoxazine ring-containing compounds, unsaturated resin systems containing double or triple bonds, polycyanate ester, bismaleimide, triazine, bismaleimide and mixtures thereof.

12. The flame retardant composition of claim 1 wherein the thermosetting resin is a modified polyphenylene ether and/or an oligomer thereof.

13. The flame retardant composition of claim 1 wherein the thermosetting resin is a modified polyphenylene ether of the general formula (IIa): 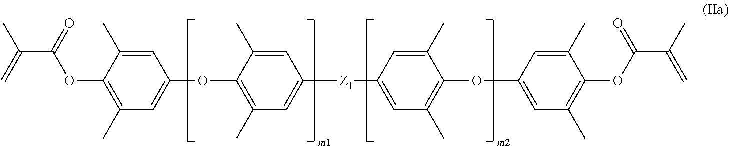
wherein Z₁ is a divalent moiety derived from compounds selected from the group consisting of bisphenol A, bisphenol F, bisphenol S, naphthalene, anthracene, biphenyl, tetramethyl biphenyl, phenol novolac, cresol novolac, bisphenol A novolak, and borane compounds, and m₁ and m₂ are each independently an integer of from about 3 to about 20.

14. The flame retardant composition of claim 1 further comprising a crosslinking agent having a carbon-carbon unsaturated double bond in an amount of from about 1% by weight to about 30% by weight.

15. The flame retardant composition of claim 1 further comprising a crosslinking agent having a carbon-carbon unsaturated double bond which is selected from the group consisting of (1) a hydrocarbon crosslinking agent; (2) a crosslinking agent containing at least three functional groups; (3) a rubber having a block or random structure; and, (4) combinations thereof.

16. The flame retardant composition of claim 15 wherein the hydrocarbon crosslinking agent (1) is selected from the group consisting of butadienes, polybutadienes, octadienes, polyoctadienes, decadienes, polydecadienes, vinylcarbazole, and combinations thereof.

17. The flame retardant composition of claim 15 wherein the crosslinking agent containing three or more functional groups (2) is selected from the group consisting of triallyl isocyanurate, 1,2,4-trivinylcyclo 1,2,4-trivinyl cyclohexane (TVCH), and combinations thereof.

18. The flame retardant composition of claim 15 wherein the rubber having a block or random structure (3) is selected from the group consisting of styrene-butadiene rubber (SBR), acrylonitrile-butadiene rubber, acrylate-butadiene rubber, acrylonitrile-butadiene-styrene rubber, and combinations thereof.

19. The flame retardant composition of claim 1 further comprising organic or inorganic fillers selected from the group consisting of Al(OH)₃, Mg(OH)₂, silica, alumina, titania and combinations thereof, in an amount of from about 1% by weight to about 50% by weight.

20. A cured flame-retardant resin made by a process comprising curing the flame retardant composition of claim 1

21. A prepreg comprising the flame retardant composition of claim 1.

22. A laminate or a bonding sheet comprising the flame retardant composition of claim 1.

23. A printed wiring board comprising prepreg of claim 21.

24. A printed wiring board comprising the laminate of claim 22.
